(19) United States
(12) Patent Application Publication
(10) Pub. No.: US 2023/0247728 A1
(43) Pub. Date: Aug. 3, 2023

(54) ULTRA-THIN HEATING DEVICE

(71) Applicant: Guangdong willing Technology Corporation, Guangdong (CN)

(72) Inventors: JINGNONG YE, Guangdong (CN); SHIFA LUO, Guangdong (CN); XINHUA TAN, Guangdong (CN)

(73) Assignee: Guangdong willing Technology Corporation, Guangdong (CN)

(21) Appl. No.: 17/987,837

(22) Filed: Nov. 15, 2022

(30) Foreign Application Priority Data
Jan. 28, 2022 (CN) 202210107531.5

(51) Int. Cl. H05B 3/34; H05B 1/02; H05B 3/16

(52) U.S. Cl. CPC H05B 3/34; H05B 1/0202; H05B 1/0252; H05B 3/16; H05B 2213/07

(57) ABSTRACT

An ultra-thin heating device includes an upper heating pad, a lower heating pad, at least one electric heating piece and a power supply. The electric heating piece is installed at a preset position between the upper heating pad and the lower heating pad. The electrothermal sheet is electrically connected with the power supply. The upper heating pad and the lower heating pad are made of soft material. When a food needs to be heated, the food is placed on the preset position of the upper heating pad corresponding to the at least one electrothermal sheet, and the power supply provides electric power to the at least one electrothermal sheet to heat the food. Because the upper heating pad and the lower heating pad are made of soft material, when not in use, the ultra-thin heating device can be folded or rolled up for storage.

### CROSS-REFERENCE TO RELATED APPLICATION

This application claims the priority benefit of China application serial no. 202210107531.5, filed on Jan. 28, 2022. The entirety of the above-mentioned patent application is hereby incorporated by reference herein and made a part of this specification.

### BACKGROUND

### Technical Field

The disclosure relates to the technical field of food heating devices, in particular to an ultra-thin heating device.

### Description of Related Art

With the increasing improvement of people's living standards, people not only pay attention to nutrition, flavor and characteristics for daily diet, but also pay more attention to maintaining the deliciousness of the food throughout the meal. At present, the existing dining table can provide convenience for the diners to obtain food, but cannot keep the hot food at a constant temperature. Hence for diner, the taste of food is degraded. Sometimes after working overtime, many people want to have hot meals at home, and they have to reheat the food, which will affect the taste of the food.

After people's continuous research, the food heating device was invented, that is, the food heating device can be placed on the table and heat food or keep the food at a constant temperature, without reheating the food. However, most of the current food heating devices are made of metal or glass materials, which take up space and are inconvenient to store when no longer in use.

### SUMMARY

Based on this, it is necessary to provide an ultra-thin heating device that can be bent and is convenient for storage.

An ultra-thin heating device comprises an upper heating pad, a lower heating pad, at least one electrothermal sheet and a power supply. The at least one electrothermal sheet is installed at a preset position between the upper heating pad and the lower heating pad. The at least one electrothermal sheet is electrically connected with the power supply. The upper heating pad and the lower heating pad are made of soft material.

In one of the embodiments, the ultra-thin heating device further comprises a marking layer which is installed on the upper heating pad and is matched to the preset position of the electrothermal sheet.

In one of the embodiments, a plurality of bumps are provided on the upper heating pad at overlapping positions with the marking layer.

In one of the embodiments, a plurality of protrusions are provided on a bottom of the lower heating pad.

In one of the embodiments, the ultra-thin heating device has nano-coatings, and the nano-coatings are respectively applied on a top layer of the upper heating pad and a bottom layer of the lower heating pad.

In one of the embodiments, the ultra-thin heating device further comprises a tableware detection unit and a control unit, and a signal output end of the tableware detection unit is connected with a signal input end of the control unit.

In one of the embodiments, the power supply comprises a temperature detection unit and a temperature control unit, and a signal output end of the temperature detection unit is connected with a signal input end of the temperature control unit.

In one of the embodiments, the power supply comprises a temperature control switch.

In one embodiment, the soft material comprises one of silica gel, rubber, leather, PVC and PP.

In one of the embodiments, a heat insulating layer is provided between the electrothermal sheet and the lower heating pad.

By means of settings of the above-mentioned ultra-thin heating device including the upper heating pad, the lower heating pad, at least one electrothermal sheet and the power supply, when the food need to be heated, the food to be heated are placed on the position of the upper heating pad corresponding to the at least one electrothermal sheet, and the power supply provides electric power to the at least one electrothermal sheet to heat the food. Because the upper heating pad and the lower heating pad are made of soft material, when not in use, the ultra-thin heating device can be folded or rolled up for storage. Because the ultra-thin heating device can be folded or rolled up, it takes up little space and is convenient for storage.

### BRIEF DESCRIPTION OF THE DRAWINGS

FIG. 1 is an explosive view of structural schematic diagram an ultra-thin heating device according to an embodiment of the present disclosure.

FIG. 2 is a schematic diagram of the assembly structure of the ultra-thin heating device of FIG. 1 according to an embodiment of the present disclosure.

FIG. 3 is a rear view of structural schematic diagram of the ultra-thin heating device of FIG. 1 according to an embodiment of the present disclosure.

### DESCRIPTION OF THE EMBODIMENTS

In order to make the above objects, features and advantages of the present disclosure more obvious and easy to understand, the specific embodiments of the present disclosure will be described in detail below with reference to the accompanying drawings. In the following description, numerous specific details are set forth in order to provide a thorough understanding of the present disclosure. However, the present disclosure can be implemented in many other ways different from those described herein, and those skilled in the art can make similar improvements without departing from the connotation of the present disclosure. Therefore, the present disclosure is not limited by the specific embodiments disclosed below.

It should be noted that when an element is referred to as being “fixed to” another element, it can be directly on the other element or intervening elements may also be present. In contrast, when an element is referred to as being “directly on” another element, there are no intervening elements present.

Unless otherwise defined, all technical and scientific terms used herein have the same meaning as commonly understood by one of ordinary skill in the art to which this disclosure belongs. The terms used herein in the description of the present disclosure are for the purpose of describing specific embodiments only, and are not intended to limit the present disclosure. As used herein, the term “and/or” comprises any and all combinations of one or more of the associated listed items.

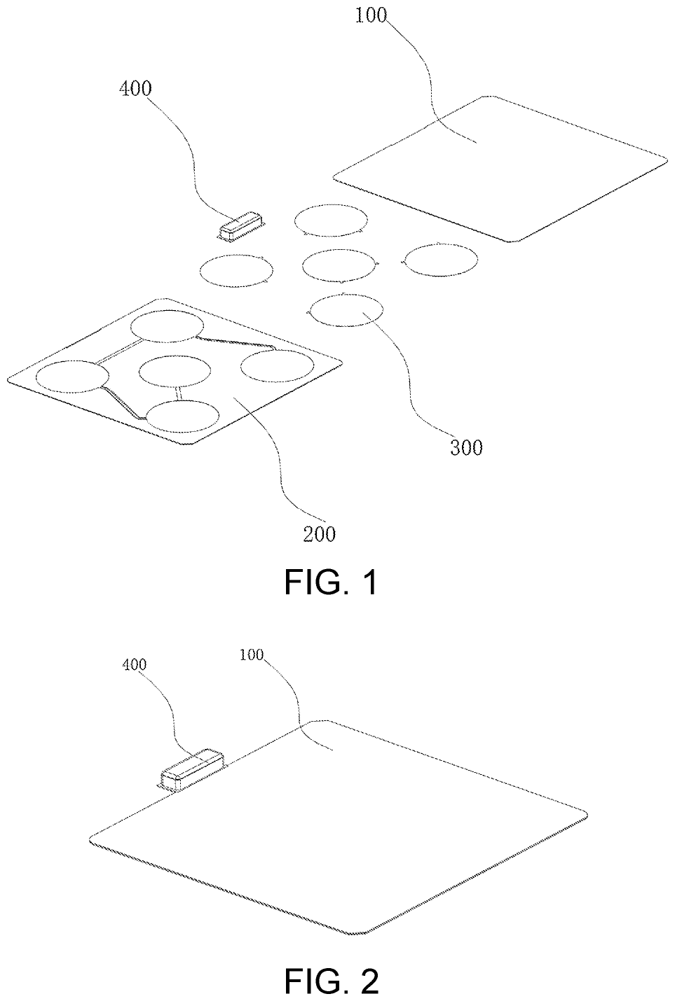

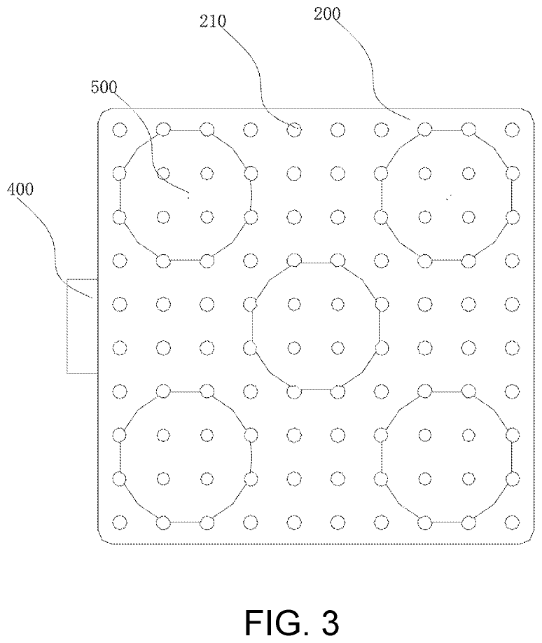

As shown in FIG. 1, FIG. 2, and FIG. 3, an ultra-thin heating device comprises an upper heating pad 100, a lower heating pad 200, at least one electrothermal sheet 300 and a power supply 400. The at least one electrothermal sheet 300 is installed at a preset position between the upper heating pad 100 and the lower heating pad 200. The at least one electrothermal sheet 300 is electrically connected to the power supply 400. The upper heating pad 100 and the lower heating pad 200 are made of soft material.

In one of the embodiments, the ultra-thin heating device further comprises a marking layer which is installed on the upper heating pad 100 and is matched to the preset position of the electrothermal sheet 300.

In one of the embodiments, a plurality of bumps are provided on the upper heating pad 100 at overlapping positions with the marking layer.

In one of the embodiments, a plurality of protrusions 210 are provided on a bottom of the lower heating pad 200.

In one of the embodiments, the ultra-thin heating device has nano-coatings, and the nano-coatings are respectively applied on a top layer of the upper heating pad and a bottom layer of the lower heating pad.

In one of the embodiments, the ultra-thin heating device further comprises a tableware detection unit and a control unit, and a signal output end of the tableware detection unit is connected with a signal input end of the control unit.

In one of the embodiments, the power supply 400 comprises a temperature detection unit and a temperature control unit, and a signal output end of the temperature detection unit is connected with a signal input end of the temperature control unit.

In one of the embodiments, the power supply 400 comprises a temperature control switch.

In one embodiment, the soft material comprises one of silica gel, rubber, leather, PVC and PP.

In one of the embodiments, a heat insulating layer is provided between the electrothermal sheet and the lower heating pad.

In one of the embodiments, the electrothermal sheet 300 is a polyimide heating film electrothermal sheet.

The upper heating pad 100 and the lower heating pad 200 can be bonded together by means of bonding, and the electrothermal sheet 300 can also be bonded to the preset position of an inner layer between the upper heating pad 100 and the lower heating pad 200 by bonding. The electrothermal sheet 300 is electrically connected to the power supply 400 through wires, and the power supply 400 is connected to an external power supply. When heating is required, the power supply 400 is supplied with power by the external power supply. Each ultra-thin heating device has at least one electrothermal sheet 300. If there are a plurality of electrothermal sheets 300, the plurality of electrothermal sheets 300 are connected by wires, and are powered by one power supply 400 together. Alternatively, each electrothermal sheet 300 may be powered by one power supply 400 to control a single electrothermal sheet 300. For example, when the ultra-thin heating device has 5 electrothermal sheets 300, the 5 electrothermal sheets 300 are respectively powered by 5 power supplies 400. When only 4 dishes need to be heated, place the 4 dishes on 4 of 5 electrothermal sheets 300 to heat, and another electrothermal sheet 300 does not need to be used, which effectively saves resources.

Polyimide heating film electrothermal sheet is made of polyimide film as an outer insulator, and metal foil and metal wire as an inner conductive heating element by high temperature and high pressure heat combination. Polyimide electrothermal film has excellent dielectric strength, excellent electrical strength, excellent thermal conduction efficiency and excellent resistance stability. Because the polyimide heating film electrothermal sheet is made of polyimide film, metal foil and metal wire, it can be bent without breaking. The upper heating pad 100 and the lower heating pad 200 are also made of soft material, which can also be bent or rolled up. When heating is required, the ultra-thin heating device is laid flat on a dining table, food to be heated are placed on the upper heating pad 100 corresponding to the electrothermal sheet 300. Then the external power supply is activated, and the electrothermal sheet 300 is powered by the power supply 400, so that the metal foil and the metal wire in the electrothermal sheet 300 are heated to heat the food. When not in use, the ultra-thin heating device is folded or rolled up for storage.

In this way, by means of settings of the ultra-thin heating device including the upper heating pad 100, the lower heating pad 200, at least one electrothermal sheet 300 and the power supply 400, when the food need to be heated, the food to be heated is placed on the position of the upper heating pad 100 corresponding to the at least one electrothermal sheet 300, and the power supply 400 provides electric power to the at least one electrothermal sheet 300 to heat the food. Because the upper heating pad 100 and the lower heating pad 200 are made of soft material, when not in use, the ultra-thin heating device can be folded or rolled up for storage. Because the ultra-thin heating device can be folded or rolled up, it takes up little space and is convenient for storage.

Further, in order to accurately obtain a heating position, the ultra-thin heating device further comprises a marking layer. The marking layer is installed on the upper heating pad 100 and is matched to the preset position of the electrothermal sheet 300.

In this way, the shape and size of the marking layer is matched to the shape and size of the electrothermal sheet 300. The marking layer can be integrally formed with the upper heating pad 100, and only distinguished by color. It is also possible to make a separate marking layer and fix it on the upper heating pad 100 at the position corresponding to the electrothermal sheet 300, so as to be distinguished from the position without the electrothermal sheet 300 on the upper heating pad 100 by using different marks. When heating the food, due to the existence of the marking layer, the position of the electrothermal sheet 300 can be accurately identified. The food to be heated is placed at the position of the electrothermal sheet 300 for heating, so as to avoid deviation of the placed position, resulting in poor heating effect or long heating time.

Further, in order to ventilate and dissipate heat during heating, a plurality of bumps are provided on the upper heating pad 100 at overlapping positions with the marking layer.

In this way, when the food is placed on the upper heating pad 100 for heating, due to the arrangement of the bumps, the container for heating the food does not completely fit the heating position on the upper heating pad 100. A gap is formed between the container for heating the food and the upper heating pad 100 to facilitate the dissipation of part of the heat on the upper heating pad 100, so as to avoid excessive heat on the upper heating pad 100 and thus the damage to the upper heating pad 100.

Further, in order to effectively protect the lower heating pad 200, a plurality of protrusions 210 are provided on the bottom of the lower heating pad 200.

In this way, the bottom of the lower heating pad 200 is usually set in close contact with the tabletop. By providing a number of protrusions 210 on the bottom of the lower heating pad 200, a gap is formed between the lower heating pad 200 and the tabletop, so that the heat that the electrothermal sheet 300 acts on the lower heating pad 200 can be quickly dissipated, which prevents the lower heating pad 200 from being damaged due to excessive temperature, and prolongs the service life of the lower heating pad 200.

Further, in order to effectively protect the ultra-thin heating device, the ultra-thin heating device has nano-coating layers, and the nano-coating layers are respectively applied on the top layer of the upper heating pad 100 and the bottom layer of the lower heating pad 200.

When heating the food, soup or water will inevitably leak out. If soup or water spills on the upper heating pad 100 or the lower heating pad 200, it will cause pollution to the upper heating pad 100 or the lower heating pad 200, and reduce the service life of the upper heating pad 100 or the lower heating pad 200. Even the electrothermal sheet 300 can be damaged because of the soup water being infiltrated into the electrothermal sheet 300. Therefore, by applying nano-coatings on the top layer of the upper heating pad 100 and the bottom layer of the lower heating pad 200, respectively, the infiltration of soup water into the upper heating pad 100 or the lower heating pad 200 to cause pollution is avoided, and the ultra-thin heating device is effectively protected for long-term use. While the nano-coating improves the waterproof level, it is also easier for the top layer of the upper heating pad 100 and the bottom layer of the lower heating pad 200 to be cleaned.

Further, in order to prevent the electrothermal sheet 300 from overheating, the power supply 400 comprises a temperature detection unit and a temperature control unit, and a signal output end of the temperature detection unit is connected with a signal input end of the temperature control unit.

The temperature detection unit is installed on the upper heating pad 100 or the lower heating pad 200 or the electrothermal sheet 300, and the temperature control unit is installed in the power supply 400. The temperature detection unit detects the temperature on the upper heating pad 100 or the lower heating pad 200 or the electrothermal sheet 300 in real time and sends the temperature value to the temperature control unit. When the temperature value exceeds a preset threshold, the temperature control unit controls the power supply 400 to stop power supply. The power supply 400 does not resume power supply until the temperature value is less than the preset threshold.

The temperature control unit comprises one of NTC and thermostat.

Further, in order to effectively control the heating temperature, the power supply 400 comprises a temperature control switch.

The temperature control switch has multiple levels, such as levels of 50°, 80°, 100°, and 120°. When a level is needed for heating, the temperature control switch is adjusted to the level. For example, in winter, when the temperature of the food is relatively low and the heating time is relatively long, then a high temperature level, for example, a 100° level or a 120° level, can be used to heat the food so as to shorten the heating time and complete the heating rapidly. In summer, when the weather is relatively hot, the temperature of the food will not be particularly low. One can use a low temperature level for heating, for example, a 50° level or an 80° level, which can not only complete the heating of the food, but also save some electricity. If the food needs to be kept warm, the temperature control switch can be adjusted to the level of 50°, so that the electrothermal sheet 300 is always kept at a temperature of about 50° to ensure that the food is always in a warm state.

Further, in order to avoid the occurrence of false heating, the ultra-thin heating device further comprises a tableware detection unit 500 and a control unit, and a signal output end of the tableware detection unit is connected with a signal input end of the control unit.

The tableware detection unit 500 is installed on the upper heating pad 100 or the lower heating pad 200, and the control unit is installed on the power supply 400 connected to an external power source. When the food is placed on the upper heating pad 100 for heating, the tableware detection unit 500 transmits a detection signal to the control unit, and when it is detected that there is a container for heating the food, the control unit controls the power supply 400 to start up to supply power to the electrothermal sheet 300 to heat the food. When the tableware detection unit 500 does not detect a container for heating the food, it will not send a signal to the control unit, and the power supply 400 will not supply power to the electrothermal sheet 300. In this way, it can be avoided that the electrothermal sheet 300 generates heat when there is no food to be heated, which can effectively save electric energy, and at the same time, can also prevent the user from being scalded. The tableware detection unit 500 comprises one of a pressure sensor, a radar sensor, a photoelectric sensor, or a tact switch.

Further, in order to prevent the lower heating pad 200 from being damaged, a heat insulating layer is provided between the electrothermal sheet 300 and the lower heating pad 200.

In this way, the heat dissipated by the electrothermal sheet 300 does not directly act on the lower heating pad 200 due to the providing of the heat insulating layer, which effectively protects the lower heating pad 200 from damage and prolongs the service life of the lower heating pad 200. The thermal insulation layer comprises one of thermal insulation sheet or aluminum foil cloth or ceramic fiber paper or glass fiber.

Further, the electrothermal sheet 300 adopts a manner of planar heating, in which the metal foils are evenly arranged, so that the food can be heated evenly, and the phenomenon of uneven heating of the food can be avoided.

The technical features of the above-described embodiments can be combined arbitrarily. For the sake of brevity, all possible combinations of the technical features in the above-described embodiments are not described. However, as long as there is no contradiction between the combinations of these technical features, all the combinations should be regarded as the scope described in this specification.

The above-mentioned embodiments only represent several embodiments of the present disclosure, and the descriptions thereof are specific and detailed, but should not be construed as a limitation on the scope of the disclosure patent. It should be pointed out that for those of ordinary skill in the art, without departing from the concept of the present disclosure, several modifications and improvements can also be made, which all belong to the protection scope of the present disclosure. Therefore, the protection scope of the patent of the present disclosure should be subject to the appended claims

What is claimed is:

1. An ultra-thin heating device, comprising an upper heating pad, a lower heating pad, at least one electrothermal sheet and a power supply,
the at least one electrothermal sheet being installed at a preset position between the upper heating pad and the lower heating pad,
the at least one electrothermal sheet being electrically connected with the power supply, and
the upper heating pad and the lower heating pad being made of soft material.

2. The ultra-thin heating device according to claim 1, wherein the ultra-thin heating device further comprises a marking layer, and the marking layer is installed on the upper heating pad and is matched to the preset position of the electrothermal sheet.

3. The ultra-thin heating device according to claim 2, wherein a plurality of bumps are provided on the upper heating pad at overlapping positions with the marking layer.

4. The ultra-thin heating device according to claim 1, wherein a plurality of protrusions are provided on a bottom of the lower heating pad.

5. The ultra-thin heating device according to claim 1, wherein the ultra-thin heating device has nano-coatings, and the nano-coatings are respectively applied on a top layer of the upper heating pad and a bottom layer of the lower heating pad.

6. The ultra-thin heating device according to claim 1, wherein the ultra-thin heating device further comprises a tableware detection unit and a control unit, and a signal output end of the tableware detection unit is connected with a signal input end of the control unit.

7. The ultra-thin heating device according to claim 1, wherein the power supply comprises a temperature detection unit and a temperature control unit, and a signal output end of the temperature detection unit is connected with a signal input end of the temperature control unit.

8. The ultra-thin heating device according to claim 1, wherein the power supply comprises a temperature control switch.

9. The ultra-thin heating device according to claim 1, wherein the soft material comprises one of silica gel, rubber, leather, PVC and PP.

10. The ultra-thin heating device according to claim 1, wherein a heat insulating layer is provided between the electrothermal sheet and the lower heating pad.
